(19) United States
(12) Patent Application Publication
(10) Pub. No.: US 2022/0153392 A1
(43) Pub. Date: May 19, 2022

(54) SYSTEM AND METHOD FOR LAYING A PIPE WITH A LARGE RADIUS OF CURVATURE AND LOW WEIGHT ON THE SEABED

(71) Applicant: OCYAN S.A., Rio De Janeiro (BR)

(72) Inventor: Rafael Machado Guigon DE ARAUJO, Rio De Janeiro (BR)

(73) Assignee: OCYAN S.A., Rio De Janeiro (BR)

(21) Appl. No.: 17/598,866

(22) PCT Filed: Jan. 21, 2020
(86) PCT No.: PCT/BR2020/050055

§ 371 Date: Sep. 27, 2021

(30) Foreign Application Priority Data
Mar. 28, 2019 (BR) BR1020190062410

(51) Int. Cl. B63B 35/03; F16L 1/235

(52) U.S. Cl. CPC B63B 35/03; F16L 1/235

(57) ABSTRACT

This invention provides a system for laying a high bending radius and low weight pipeline on the seabed comprising a subsea pipe-laying vessel comprising a moonpool and at least one coil with at least one pipeline segment to be installed wrapped around it, in which the moonpool comprises an internal baffle element adapted to smooth out the pipeline bend due to the of the pipe-laying vessel movement regarding the seabed, current, and catenary angle, where the system comprises at least one supporting element to support at least one coil allowing it to rotate to unwind the pipeline and where at least one supporting element comprises a handling system allowing the movement of at least one supporting element and at least one coil in at least one axis. A method of laying a pipeline on the seabed is also provided, performed using the described system.

### FIELD OF INVENTION

This invention is related to the technical field of oil and gas exploration. More specifically, this invention is related to an alternative, simplified method for installing subsea pipelines using a moonpool vessel.

### INVENTION GROUNDS

In the hydrocarbon production area, several methods and systems are known for pipeline installation, including methods for installing low submerged weight and high bend radius, pipelines such as composite pipelines. However, such methods involve the use of specialized vessels for the laying flexible composite pipelines.

However, a common problem encountered in such methods lies in the complexity of their operation due to the components that comprise the used systems.

The paper WO2007108673A1, for example, reveals a system that makes use of tensioners supporting the pipeline load on its way to the seabed. However, the tensioners are very costly elements that should preferably be avoided, in order to minimize these operations' costs.

Optionally, in the state of the art, composite the pipeline installation is done by a “handheld” system comprising a coil, a deflector, and a tensioner, installed in a moonpool vessel. However, this method limits the catenary top angle since it concentrates the deflection at the tensioner exit or at a guide element positioned below the tensioner. Here it is important to point out that, in case of composite pipelines installation, due to the reduced mass of that type of pipeline, the top angle is even more sensitive to current variations.

Several other methods of composite pipeline installation are known, such as those described in the documents that will be presented below, in order to illustrate the variety of currently known options.

The paper U.S. Pat. No. 8,915,674B2 describes a method for installing a fitting on a pipeline to be laid on the seabed, including the pipeline launching from a first position on a tower, in which the tower is at an angle a to the vertical. It should be noted that this document shows a system for launching a pipeline into the sea that includes a complex system where the coil is attached to the upper part of the tower, and where the tower is tilted to achieve the desired tilt angle.

The paper WO2015069099A1 shows a system for launching a pipeline comprising a coil installed on the launching vessel floor and a launching tower, where the pipeline passes from the coil, through a second coil attached to the launching tower before being inserted into the moonpool for launching.

The paper U.S. Pat. No. 9,631,742B2 shows a marine pipeline installation vessel for laying pipelines on the seabed, which has a pipeline guide mounted in an elevated position relative to the pipeline launching tower, where the contact point is positioned forward and aft of the launching line (moonpool).

The paper WO1996035902A1 shows a method for laying pipelines on the seabed, which is suitable for use on a drilling vessel temporarily converted to a pipe laying vessel, having an uncoiled pipe coil on a bending shoe, on which the pipe is straightened before being joined and fed through a moonpool onto the seabed.

The paper WO2012091556A1 shows a marine pipeline installation system for pipeline laying and installation of subsea risers, which has a guide support structure that allows the pipeline guide movement in the combined upward and reel direction.

The paper U.S. Pat. No. 5,573,353A shows a vertical coil pipeline launching vessel comprising a guide element, including supports for an aligner wheel on the vessel to allow rotational movement about the axis of the aligner wheel.

The paper GB2287518A shows a method of laying marine pipeline involving the pipe section mounting with the horizontal axis on the vessel deck, the pipeline being bent as it is laid, and includes moving the pipeline up or down, until it finds the final launching angle.

The paper CN201647090U shows a pipeline launching vessel comprising a roll lifting mechanism that drives the winding cylinder, to move up and down along a central moonpool, wherein the vessel further comprises supporting brackets, four feet of lifting and a power device.

As it can be seen from the examples illustrated above, the state of the art comprises a plurality of methods and systems to assist in the installation of subsea pipelines (possibly composites) on the seabed.

However, the presented methods and systems comprise high complexity and, consequently, high costs are involved in their operations, especially in composite pipeline installation applications. Thus, it is clear that the state of the art lacks a system and method for installing low complexity, simple execution and high strength composite subsea pipelines on the seabed, which would speed up the process, cause a cost reduction for the industry, besides reducing the risks involved in the operation.

As will be further detailed below, this invention aims at solving the above described prior art problems in a practical and efficient way.

### SUMMARY OF THE INVENTION

The present invention aims at providing a system and a method for installing subsea pipelines with a high bending radius and low weight on the seabed that is simple to execute and that comprises elements requiring low maintenance.

In order to achieve the above objectives, this invention provides a system for installing a high bend radius and low weight pipeline on the seabed, comprising a subsea pipeline installation vessel comprising a moonpool, and at least one spool with at least one pipeline segment to be installed wound on it, wherein the moonpool comprises an internal baffle element adapted to smooth out the pipeline bend due to the installation vessel movement relative to the seabed, wherein the system comprises at least one supporting element for at least one coil, allowing it to rotate in order to unwind the pipeline, and wherein at least one supporting element comprises a movement system allowing at least one supporting element and at least one coil to move in at least one axis.

Moreover, a method of installing a high bend radius and low weight pipeline on the seabed, comprising the use of a subsea pipeline installation vessel comprising a moonpool, and at least one spool with at least one pipeline segment to be installed wound on it is also provided, the method comprising the steps of: place at least one coil in an installation position regarding the moonpool, where the installation position is a point where the pipeline is freely inserted into a moonpool top opening; at least rotate the coil to unwind the pipeline and allow it to be inserted into the moonpool; smooth out the pipeline bend due to the installation vessel movement relative to the seabed, through the use of a baffle; and move at least one coil on at least one axis.

### BRIEF DESCRIPTION OF THE FIGURES

The detailed description presented below refers to the attached figures and their respective reference numbers.

FIG. 1 shows a schematic side view of a pipeline installation system of this invention according to an optional setup in which only one pipeline coil is used.

FIGS. 2a, 2b, and 2c show side views of the particular setup of a pipeline installation system in FIG. 1, in which the pipeline coil transverse movement can be seen.

FIGS. 3a and 3b show schematic views of the installation system of a pipeline in FIG. 1, in a situation where the support is moved to reduce the friction and contact force between the pipeline and the baffle inside the moonpool.

FIGS. 4a and 4b show schematic views of a particular setup of this invention in which a structural element (for example, a flotation module, or a dead weight) is installed attached to the pipeline.

FIG. 5 shows a schematic side view of a pipeline installation system of this invention according to an optional setup in which three pipeline coils are used.

FIG. 6 shows a schematic view of the system side for installing a pipeline of this invention according to a second optional setup in which three pipeline coils are also used. In this case, the first coil serves as a deflector for the other coils. The first coil rotates so that the tangential velocity is similar to that of the coil in which the pipeline is stored.

FIG. 7 shows a schematic view of a pipeline installation system of this invention illustrating the connection between a pipeline already launched from a first coil, and a subsequent pipeline to be launched from a second coil.

FIG. 8 shows an optional setup of the system of this invention, in which a second baffle is used at the stern of the installation vessel to aid in the installation of very large elements that cannot be installed through the moonpool.

### DETAILED INVENTION DESCRIPTION

Preliminarily, it is emphasized that the description that follows will start from a preferred embodiment of the invention. As it will be clear to anyone skilled in the art, however, the invention is not limited to this particular implementation.

For the purposes of this description, the installation of composite pipelines will be considered as an example of this invention's use. However, it is emphasized that this invention is by no means restricted to composite pipelines, since it can be used in any pipelines having a high bending radius and low submerged weight. For the sake of clarity, pipelines having a minimum bend radius greater than 4 meters are considered to be pipelines having a high bend radius. Additionally, pipelines with a low submerged weight are considered to be pipelines having a submerged weight of less than 70kgf per meter.

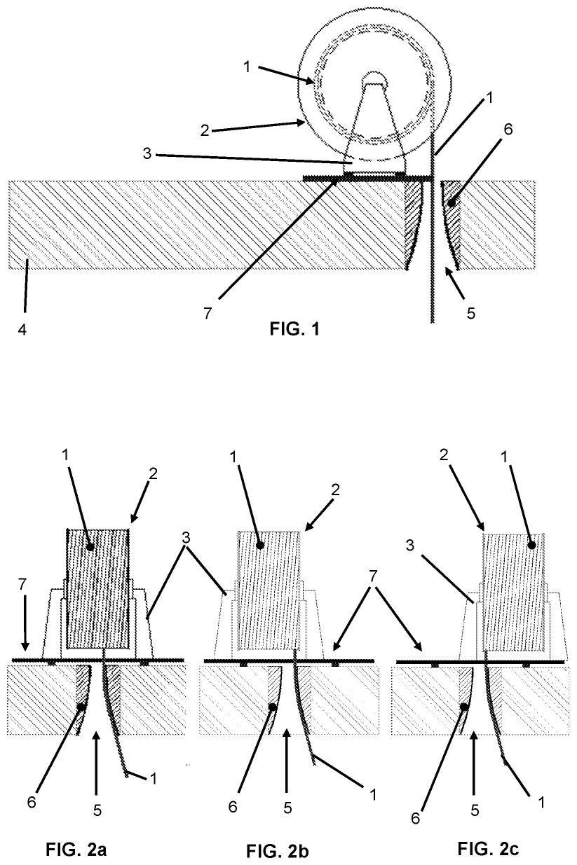

The FIG. 1 shows a schematic side view of the system for installing a composite pipeline according to an optional setup of this invention, in which only one coil 2 of composite pipeline 1 is used.

According to this more general configuration, the system for installing a composite pipeline 1 on the seabed comprises a subsea pipeline installation vessel 4, which in turn comprises a moonpool 5, and at least one reel 2 with at least one segment of composite pipeline 1 to be installed wound onto it.

In an innovative way, the invention further provides that the moonpool 5 comprises an internal deflector element 6 adapted to smooth out the curvature of the pipeline 1 bend due to the installation vessel 4 movement relative to the seabed.

At this point, it is important to point out that baffle element 6 represents the last contact point between the composite pipeline 1 and the installation vessel 4.

Optionally, the baffle element 6 is removable from the moonpool 5, allowing some structures to pass through the interior of moonpool 5.

In addition to that, it is also provided that a support element 3 is used to support at least one reel 2, wherein at least one supporting element 3 allows the reel 2 to rotate in order to unwind the composite pipeline 1.

At least one supporting element 3 further comprises a movement system 7 that enables the movement of at least one supporting element 3 and the at least one coil 2 in at least one axis (preferably longitudinal and/or transverse).

It is noted that this invention's system is shown to be extremely simplified and easy to operate, in that the entire weight of coil 2 and the pipeline 1 is fully supported by the supporting element 3 of coil 2.

Thus, similarly, the invention also provides a method of installing a composite pipeline 1 on the seabed comprising the use of a subsea pipeline installation vessel 4, comprising a moonpool 5, and at least one coil 2 having at least one segment of composite pipeline 1 to be installed wound thereon, wherein the method initially comprises a step of positioning at least one coil 2 in an installation position regarding the moonpool 5, wherein the installation position is a point at which the composite pipeline 1 is freely inserted into a top opening of moonpool 5.

Next, the step of rotating at least one coil 2 is envisaged to unwind the composite pipeline 1 and allow the composite pipeline 1 to be inserted into the moonpool 5.

In order to avoid the composite pipeline 1 from being damaged, a step is provided to smooth the composite pipeline 1 bend the due to the installation vessel 4 movement relative to the seabed, through the use of a deflector 6. Besides, the baffle element 6 prevents the minimum bend radius supported by the composite pipeline 1 from being breached.

In addition, a step of moving at least one coil 2 in at least one axis is also foreseen.

FIGS. 2a, 2b, and 2c show front views of the particular system setup for installing a composite pipeline 1 of FIG. 1. In that sequence of figures it is possible to observe the transversal movement of the coil 2, through the transversal movement of the supporting element 3. That movement occurs mainly to follow the composite pipeline movement 1 as it is installed, avoiding too sharp angles to be formed in the composite pipeline 1 contact with baffle 6.

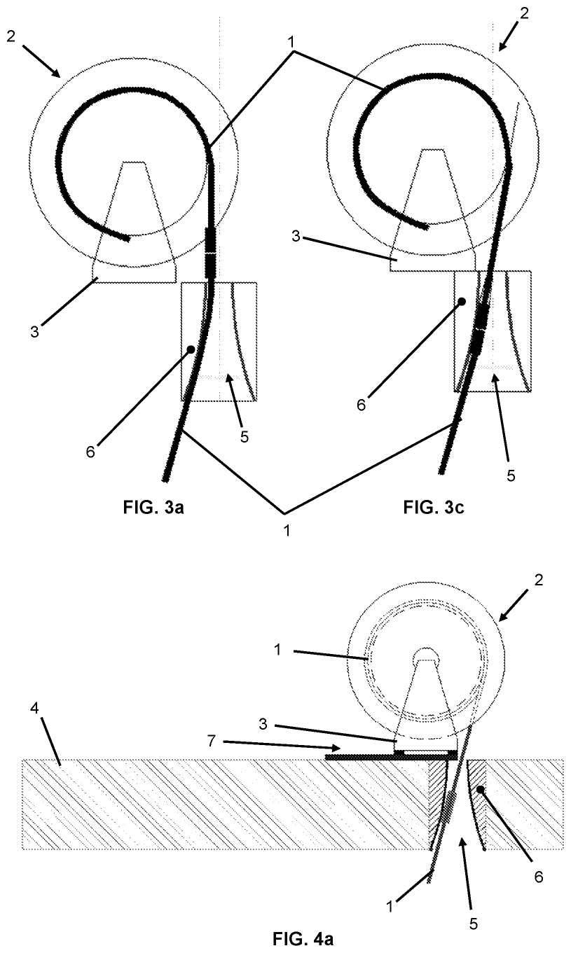

FIGS. 3a and 3b show schematic side views of the installation system of a composite pipeline 1 from FIG. 1, in a situation where the support 3 is moved longitudinally in order to reduce the friction between the composite pipeline 1 and the baffle 6 internal to the moonpool 5 due to tilting caused by the movement of the installation vessel 4.

According to a preferred setup of this invention, as illustrated in FIGS. 2a, 2b, 2c, 3a and 3b, the movement system 7 of at least one supporting element 3 is adapted to allow the movement of at least one supporting element 3 in at least two coplanar axes, being one longitudinal axis (FIGS. 3a and 3b) and one transverse axis (FIGS. 2a, 2b, 2c).

With these two movement axes of the supporting element 3, the invention ensures that the coil 2 is moved both transversely and longitudinally, so that the composite pipeline 1 is always inserted into the moonpool 5 with reduced friction, even as the vessel 4 moves.

According to this invention, the moving system 7 of the supporting element 3 may comprise any currently known option, or one to be developed in the future. For example, the movement system 7 may comprise a rail system, a curler system, a magnetic movement system 7, among others.

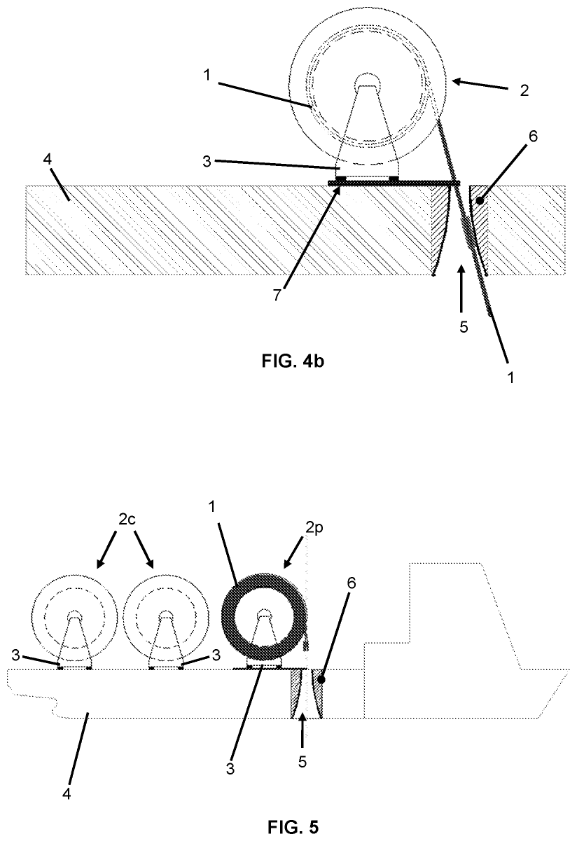

FIGS. 4a and 4b show schematic views of a particular setup of this invention in which a larger diameter structural element is attached adjacent to the composite pipeline 1. In these figures, it can be seen that the system of this invention also allows the composite pipeline 1 to be installed along with some larger diameter structural element attached to it. In that case also, coil 2 can be moved to adapt the pipeline to the entry angle.

In any of the shown setups, optionally, the baffle 6 can comprise convex bent walls to attenuate the bend of the composite pipeline 1 when passing through the moonpool 5. In alternative setups, the baffle 6 walls may comprise a conical parabolic shape, or any other shape that enables to attenuate the bend of the composite pipeline 1 when passing through moonpool 5.

Also optionally, the baffle 6 may comprise an upper opening and a lower opening where the lower opening comprises a diameter larger than the upper opening. This configuration, although preferential, is not a limiting factor, so other configurations can be used, varying from application to application.

FIG. 5 shows a schematic front view of the system for installing a composite pipeline 1 of this invention according to an optional setup in which three coils 2 of composite pipeline 1 are used. Although three 2p, 2c coils are shown, it is important to note that any number of 2p,2c coils can be used, where this optional configuration provides for the use of more than one 2p,2c coil, from two 2p,2c coils to several of these.

Optionally, coils 2p,2c can be positioned in an aligned manner so that when composite pipeline 1 of the first coil 2p is fully installed, the composite pipeline 1 of the second coil 2c is connected to the first one, continuing the installation process.

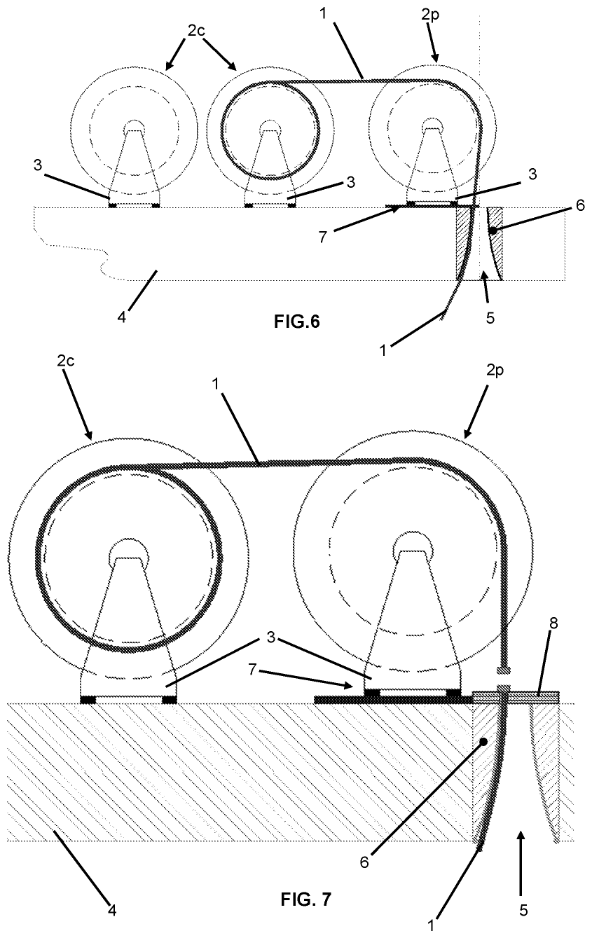

FIG. 6 a schematic view of the front end of the system for installing a composite pipeline 1 of this invention according to an optional second setup in which three coils 2p,2c of composite pipeline 1 are also used.

Preferably, when more than one coil are used, the coil closest to moonpool 5 is set as the main coil 2p, and the remaining coils are set as loading coils 2c.

When the system having several coils 2p,2c is used only the main coil 2p can have a longitudinal movement system, while the loading coils 2c should comprise a transverse translation system and also a traction system. The main coil 2p then serves to offset the pipeline from the horizontal plane to the vertical plane and route the pipeline to moonpool 5. For this purpose the main coil 2p should be empty.

In that configuration, when completing the installation of composite pipeline 1 of a given 2p,2c coil (initially it will be the composite pipeline 1 of the main coil 2p), a leading end of composite pipeline 1 from the subsequent coil is connected to a trailing end of composite pipeline 1 of the newly installed coil, following the installation in a simple and fast way.

Similarly as described above, when all composite pipeline 1 of the first loading coil 2c has been installed, it should be connected to the composite pipeline 1 of the subsequent loading coil 2c to continue the installation. It is emphasized again that the total number of used 2p, 2c coils may vary from application to application.

FIG. 7 shows a schematic view of the installation system for a composite pipeline 1 of this invention showing the connection between a composite pipeline 1 already launched from a first main coil 2p, and a subsequent pipeline to be launched from a second loading coil 2c.

According to this optional setup, after launching a composite pipeline 1 from a coil 2p, the trailing end of the first pipeline is supported on a supporting platform 8, then a starting end of the composite pipeline 1 from the subsequent coil 2c is connected to the trailing end of the initial coil composite pipeline 1 (main 2p). After the two ends are connected, the supporting platform 8 is removed and the launching of composite pipeline 1 is continued.

Additionally, it is possible to include a distance sensor system in the lower edge of the moonpool 5 to ensure that the pipeline does not touch the lower moonpool 5 edge which could cause damage to the pipeline. In that configuration, when the distance sensor identifies that the composite pipeline 1 is in a risky position, at least one coil 2 can be moved in order to correct the pipeline 1 positioning.

It is important to point out that the this invention's system can be managed by a sensor-powered control system, so that its elements are moved and positioned automatically as a function of the installation vessel 4 movements due to the tide, wind, or any other factors. In that configuration, the system would be autonomous and even more secure.

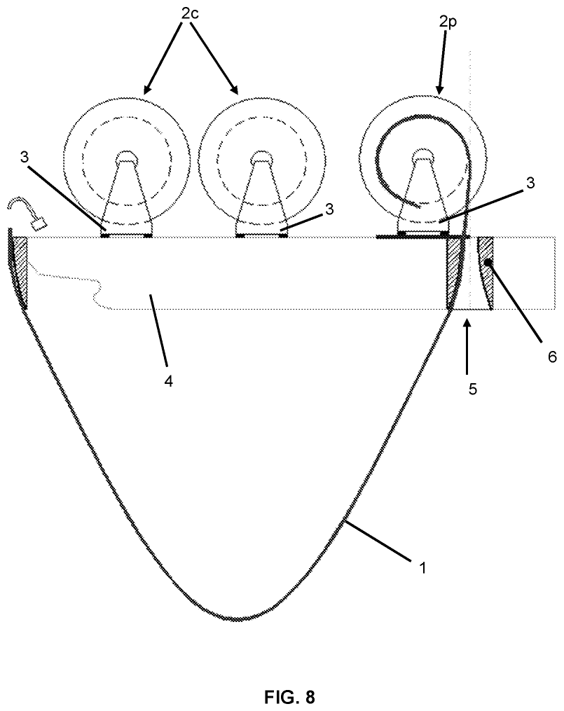

FIG. 8 shows an optional configuration of the system of this invention in which a second baffle 6 is used at the stern of the installation vessel 4 to assist in the installation of very large diameter elements that cannot be installed through the moonpool 5.

Thus, it is clear that the invention outlined in the preceding paragraphs provides innovative method and system for installing a composite pipeline 1 on the seabed, allowing to perform such operation in a very simplified, and consequently more agile and cheaper way, in comparison with the methods and systems currently known.

Moreover, the system of this invention, despite its simplicity of operation, demonstrates a great ability to adapt to high angles, a problem often faced in the installation of composite pipelines, due to the light weight of this type of pipeline.

In addition to that, the method described herein allows the installation of large diameter pipelines, which consequently have little bending capacity, i.e., which need large bending radii for storage and for the baffle 6, which in the case of the traditional system would lead to impractical dimensions for the installation system.

In the case of this invention, since the deflector 6 covers a reduced angle (typically)20°, it is possible to accommodate a high bending radius without having much impact on the overall dimensions. In the traditional case the deflector 6 covers a 180° angle.

Countless variations affecting the protection scope of this application are allowed. Thus, it is highlighted that this invention is not limited to the particular configurations/achievements described above.

1. A pipeline installation system with a high bending radius and low seabed weight comprising a launching vessel of subsea pipelines comprising a moonpool and at least one coil with at least one pipeline segment to be installed wrapped around it, the system being characterized by the moonpool comprising an internal baffle element adapted to smooth the pipeline bend due to the installation vessel movement regarding the seabed, to prevent the minimum bend radius supported by the pipeline from being breached,
where the system comprises at least one supporting element to support at least one coil, allowing it to rotate to unwind the pipeline,
where at least one supporting element comprises a handling system allowing the movement of at least one supporting element and at least one coil in at least one axis.

2. The system, according to claim 1, characterized by the fact that the movement system of at least one supporting element is used to allow the movement of at least one supporting element on at least two coplanar axes, being a longitudinal axis and a transverse axis.

3. The system, according to claim 1, characterized by the movement system of the supporting element comprising one of each: a rail system; a curler system, and a magnetic moving system.

4. The A system, according to claim 1, characterized in that the deflector comprises convex bent walls adapted to attenuate the pipeline bend when passing through the moonpool.

5. The system, according to claim 1, characterized by the deflector comprising an upper and a lower opening, where the lower opening comprises a diameter larger than the upper opening.

6. The system, according to claim 1, characterized by comprising a main coil positioned closest to the moonpool and at least one charging coil farther away from the moonpool, where the main coil comprises a longitudinal handling system, while at least one charging coil comprises a transversal translation system and also a traction system.

7. The system, according to claim 1, characterized by comprising a supporting platform adapted to support one end of the first pipeline already installed, in order to connect the starting end of a second pipeline to be installed.

8. The system which, according to claim 1, is characterized for comprising a distance sensor system on the lower edge of the moonpool.

9. The system which, according to claim 1, is characterized by comprising a control system powered by at least one sensor, wherein the control system is adapted to move the system elements in response to the installation vessel movements or in response to elements in the system itself.

10. The system which, according to claim 1, is characterized for comprising a second deflector at the stern of the installation vessel adapted to assist in the installation of very large diameter elements that cannot be installed through the moonpool.

11. The system, according to claim 1, is characterized by the baffle element being removable from the moonpool.

12. An installation method of a high bending radius and low weight pipeline on the seabed comprising the use of subsea pipelines laying vessel comprising a moonpool and at least one coil with at least one pipeline segment to be installed wrapped around it,
characterized by comprising the stages of:
positioning at least one coil in an installation position regarding the moonpool where the installation position is a point at which the pipeline is freely inserted into a moonpool top opening;
rotate at least the coil to unwind the pipeline and allow it to be inserted into the moonpool;
smooth out the pipeline bend due to the installation vessel movement regarding the seabed, current, and catenary angle, through the use of a deflector; and
move at least one coil in at least one axis.

13. The method which, according to claim 12, is characterized for comprising the step of moving at least one supporting element on at least two coplanar axes, being a longitudinal axis and a transverse axis.

14. The method which, according to claim 12, is characterized by the fact that upon completion of the pipeline installation of a given coil, a starting end of the pipeline from the coil subsequently is connected to one end of the coil newly installed pipeline.

15. The method which, according to claim 12, is characterized by the fact that after launching a coil pipeline, the end side of the first pipeline will be supported on a supporting platform, then, a starting end of the coil pipeline subsequently is connected to the final end of the coil initial pipeline, where after the two ends are connected, the supporting platform is removed and the pipeline is continued.
